(19) United States
(12) Patent Application Publication
(10) Pub. No.: US 2025/0387980 A1
(43) Pub. Date: Dec. 25, 2025

(54) INDUCTION HEATED CORNER KEYS

(71) Applicant: Erdman Automation Corporation, Princeton, MN (US)

(72) Inventor: Morgan Donohue, North Oaks, MN (US)

(21) Appl. No.: 18/748,481

(22) Filed: Jun. 20, 2024

(51) Int. Cl. B29C 65/36; B29C 65/00; B29K 27/06; B29K 105/16; B29K 105/20; B29K 505/00; B29K 705/00

(52) U.S. Cl. CPC B29C 65/3668; B29C 66/52231; B29K 2027/06; B29K 2105/16; B29K 2105/206; B29K 2505/00; B29K 2705/00

(57) ABSTRACT

An induction heatable corner key, including a generally L-shaped body having an electrically conductive portion and an electrically non-conductive portion wherein the electrically conductive portion is formed of a material that is subject to inductive heating and of sufficient mass to transfer heat to the electrically non-conductive portion and to render the non-conductive portion at least partially molten. And, A method of joining polymer parts, including preassembling at least a first polymer frame part and a second polymer frame part with an induction heatable corner key coupling the first polymer part to the second polymer part and subjecting at least a portion of the induction heatable corner key and at least a portion of each of the first polymer part and the second polymer part to induction heating sufficient to render them molten, terminating the induction heating, and allowing the molten portions to cool and harden.

### TECHNICAL FIELD

Example embodiments of the invention relate to the manufacturer and construction of vinyl windows and vinyl window frames from frame components. Example embodiments also relate to an alternative method of polymer welding of vinyl window structures.

### BACKGROUND

Sashes and window frames may be manufactured from a variety of materials including wood, aluminum extrusions and plastic extrusions. Plastic extrusions are commonly made from a thermoplastic polymer, for example polyvinylchloride (PVC). Polyvinyl chloride is commonly known as vinyl.

Wooden or aluminum frame or sash materials are commonly joined with the use of adhesives. Plastic frame or sash materials are generally joined by the application of plastic welding techniques. Plastic welding techniques may, for example, include techniques in which the ends of two pieces of material that are to be joined are heated until at least partially molten and then pressed together while the heated materials at the ends are still molten thereby fusing the two pieces together permanently as the molten material cools and hardens.

Typically, in the known prior art, cycle times for manufacturing PVC frames or sashes require about 30 to 40 seconds for loading of the pieces to be welded followed by 5 to 10 seconds for referencing the pieces relative to each other. Heating of the portions to be welded generally takes about 20 seconds while mating and fusing of the pieces requires approximately 20 seconds. Finally, offloading the welded product generally requires about 15 seconds. This means that a manufacturing operation requires a total cycle time of about one to one- and one-half minutes per welded frame or sash.

One challenge of welding sashes or frames of vinyl is that as a weld is accomplished weld flashing is created. Weld flash protrudes from the surface of the sash or frame at the location of the weld and must be removed and consists of molten plastic that has squeezed out of the joint and has re-hardened. The removal of weld flashing is generally referred to by those skilled in the art as corner cleaning and is accomplished by machining away the hardened weld flashing. A typical cycle time for corner cleaning is 60 to 90 seconds. Prior to corner cleaning the welds must cool enough so that the weld flashing hardens sufficiently to permit proper machining of the protruding flashing material. Premature machining of flashing material will foul the cutting tools with molten plastic. The length of time required for hardening of the flashing material varies depending upon environmental conditions but, under some common circumstances is approximately 1 minute.

These frames and sashes are commonly used in concert with insulated glass units. Insulated glass generally includes at least two panes of similarly shaped glass, called lites, separated from one another by a perimeter spacer. The two or more lites bonded together with the peripheral perimeter spacer are referred to as an insulated glass unit (IGU). Building codes in many areas of the country require insulated glass installation as an energy conservation measure, particularly for large commercial properties, because insulated glass units (IGUs) have much greater insulating value than a single pane of glass alone.

Commonly, finished welded sashes or frames are conveyed to another area of the manufacturing floor for the corner cleaning process. Some prior art corner cleaning processes utilize a rotating head robot for corner cleaning.

Some prior art welding machinery utilizes a pre-clamping option. That is, in an effort to expedite the welding process, sash or frame parts are pre-clamped in proper relative position and orientation prior to being subject to the heating and fusing stages of the welding process. The sash or frame parts are pre-clamped so that the corners are separated from one another and do not meet until after heat is applied to the corners for fusing.

Commonly window manufacturers find that approximately 60% to 70% of their manufacturing volume falls into three size categories that are relatively standard. This means that a large fraction of the manufacturing volume can be processed by setting up manufacturing machinery to process these commonly produced sizes.

For the purpose of welding, PVC begins to soften at about 140° C. Heating plates that are utilized in the heating process generally are maintained at a temperature of about 500° C.

Frames for vinyl windows and vinyl sashes are typically assembled from hollow vinyl extrusions which are typically mitered at the corners. Very often such extrusions are joined together by polymer welding. While polymer welding is quick and effective, the fused area of the joined pieces is small and stress on the frame may become localized in this area.

Thus, the preparation of welded polymer window frames remains a complex process that requires the application of multiple manufacturing steps and multiple potentially complicated machines that might benefit from simplification.

Accordingly, there is still room for improvement in the area of frame and sash manufacturing.

### SUMMARY

Example embodiments of the invention include induction heated corner keys used to facilitate the assembly of vinyl window frame structures such as vinyl window sashes. Induction heated corner keys according to example embodiments of the invention are inserted into hollow vinyl extrusions that are used to manufacture window frames. Following pre-assembly of the frame parts and the corner keys, the induction heated corner keys are subject to electromagnetic frequency radiation to excite conductive portions of the corner keys thus heating the conducting portions and surrounding polymer portions to facilitate fusion and permanent attachment of the structures involved. Thus, the frame members and the corner keys form a complete frame that is reinforced at the corners and held at proper relative angles by the presence of the corner keys.

It is expected that the use of induction heated corner keys will expedite the assembly of vinyl window parts for such structures as sashes and frames. It is also expected that the use of induction heated corner keys, according to example embodiments of the invention, will mitigate the need for at least some equipment currently utilized in the construction and welding of polymer window frames. In addition, it is expected that the use of induction heated corner keys according to example embodiments of the invention will improve the strength and squareness of window frame structures that are produced. Squareness of the window frame structures generally relates to rectangular frame structures. However, use of example embodiments of the invention is expected to also facilitate accuracy of angular joints that meet at angles other than ninety degrees, for example, joints of octagonal window frame structures that are one hundred thirty-five degrees.

According to an example embodiment, an induction heatable corner key includes a metal key body with a polymer coating overlying the metal key body. The example, induction heated corner key is preassembled into the corners of a polymer, for example vinyl, window frame structure. The corners of the vinyl window frame structure are then subjected to induction which excites and heats the metal portions of the key body and causes surrounding polymer material to melt. Polymer material of the corner key melts and fuses with polymer material of the frame members. Upon cooling the fused polymer material hardens causing a permanent strong attachment between the corner key and the frame members.

According to another example embodiment, a polymer key includes a polymer body with protruding metal barbs or angled metal tabs extending outwardly from a surface thereof. The metal barbs or tabs are angled substantially in the same direction and are biased outwardly. The angled orientation of the metal barbs or tabs is such as to facilitate insertion of the corner key into each of the hollow extruded frame members and to resist removal of the corner key from the hollow extruded frame members once inserted. The frame is preassembled with the corner keys and then subjected to heating by induction of the corner key. When excited by the electromagnetic frequency radiation, the heated barbs or tabs melt the surrounding polymer of the frame member and spring outwardly to be embedded in the molten outer polymer of the frame member. Upon cooling the barbs or tabs are surrounded by the molten polymer and the polymer hardens and permanently joins the structures together.

According to a further example embodiment, any variant of the corner keys can further include a butyl rubber sealant or other sealant that facilitates sealing of the angled seam of the frame members which is typically but not always forty-five degrees. Depending on the shape of a window frame structure the angle may vary. For an octagonal window the angle is expected to be twenty-two and one-half degrees. Upon preassembly and heating the sealant softens and tends to seal the mitered joint to mitigate the likelihood of water entry into the frame members.

According to another example embodiment, a polymer corner key includes a metal mesh or expanded metal screen material partially embedded in its surface. The metal screen material is embedded so as to partially protrude outwardly from the surface. Similar to the other example embodiments, this corner key is preassembled by being force fit into the polymer frame members to be joined. Once preassembled, the corner keys are subjected to induction heating. The portion of the metal mesh protruding outwardly from the surface becomes hot and melts the adjacent polymer of the surrounding interior of the polymer frame number. Once surrounded by the molten polymer, induction heating is stopped and the molten material is allowed to cool and harden thus permanently embedding the wire mesh in both the polymer body of the corner key and the surrounding polymer of the frame member.

According to another example embodiment, a polymer key with metal particles incorporated into the surface of the polymer key is utilized. The metal particles may include shavings, beads or other forms. Such a polymer key can, for example, be manufactured by magnetizing a ferrous metal mold, adding particles to the interior of the mold and then injecting polymer into the mold thus embedding the particles at or near the surface of the polymer corner key. Similar to the other described embodiments, the corner key is preassembled with frame members of the window structure and then subjected to inductive heating which causes the polymer in the vicinity of the metal particles to melt and surround the metal particles. Upon cooling, the metal particles are permanently embedded in the polymer of both structures at the junction between the corner key and the interior of the extruded frame member and the polymer of the corner key and the frame member fuses thus permanently bonding the two together.

According to a further example embodiment, a thin metal structure having multiple tabs bent and biased outwardly therefrom is secured to the polymer corner key at or proximate a surface thereof. Alternately, some metal tabs are bent inwardly and some are bent outwardly. The metal tabs are oriented to facilitate insertion into an extruded frame member and to resist removal from the extruded frame member. Similar to previously described embodiments, the frame member and thin metal structure are subjected to inductive heating thus rendering the surrounding polymer molten and permanently fusing the frame member, the thin metal structure and the polymer corner key together upon cooling and hardening of the polymer.

According to another example embodiment, a polymer key in accordance with the invention has a plurality of indentations at the surface of the polymer key. The indentations can be in the form of grooves or dimples, for example. The indentations are filled with an induction heatable and meltable material. For example, the indentations can be filled with an iron vinyl mixture for example including iron filings in a vinyl or other polymer material. Alternately the indentations can be filled with an electrical conducting polymer that heats and subsequently melts when subject to induction heating via electromagnetic field. The filling and surrounding polymer melt and upon cooling fuse the structures together.

According to further example embodiments, the polymer corner keys also may include hardware such as tilt latches, locking mechanisms or tilt hinges thus facilitating the manufacture of frames expeditiously without additional steps to install hardware. According to a further example embodiment locking hardware may be incorporated into the polymer corner keys at least at the corners of sashes.

In the context of this application, corner keys may be referred to as generally L-shaped as described herein. For the purposes of the application, the term “generally L-shaped” should be understood to mean a structure having a first arm and a second arm that meet at a corner at an angle from sixty degrees to an angle of one hundred fifty degrees.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 depicts a corner key according to an example embodiment of the invention having a metallic core and a polymer coating;

FIG. 2 depicts a corner key according to an example embodiment of the invention having a polymer core and metallic barbs;

FIG. 3 depicts a corner key according to an example embodiment of the invention having a polymer core and metallic tabs;

FIG. 4 depicts a corner key according to an example embodiment of the invention having a polymer core and metallic screen;

FIG. 5 depicts a corner key according to an example embodiment of the invention having metallic particles on a surface thereof;

FIG. 6 depicts a corner key according to an example embodiment of the invention with a metal structure having multiple tabs extending inwardly and outwardly;

FIG. 7 depicts a corner key according to an example embodiment of the invention including grooves filled with an induction heatable polymer material;

FIG. 8 depicts a sectional view of the corner key as depicted in FIG. 7 according to an example embodiment of the invention;

FIG. 9 depicts a corner key according to an example embodiment of the invention including incorporated hardware;

FIG. 10 is an exploded view of four corner keys and four polymer frame members; and

FIG. 11 is a block diagram illustrating a method according to an example embodiment of the invention.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

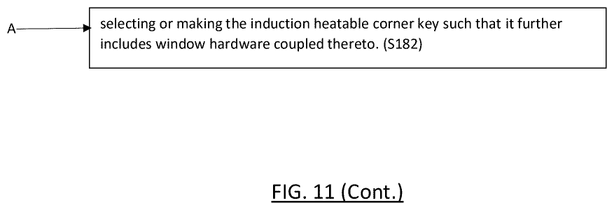

Referring to the drawing figures and particularly to FIG. 10, according to an example embodiment of the invention, frame 50 for a fenestration structure 52 generally includes four extruded frame members 54 which are typically hollow and formed of a thermoplastic polymer and corner keys 56. Corner keys 56 are inserted into ends 58. Ends 58 are generally miter cut at a 45° angle. The polymer is commonly a thermoplastic polymer, for example polyvinyl chloride (PVC).

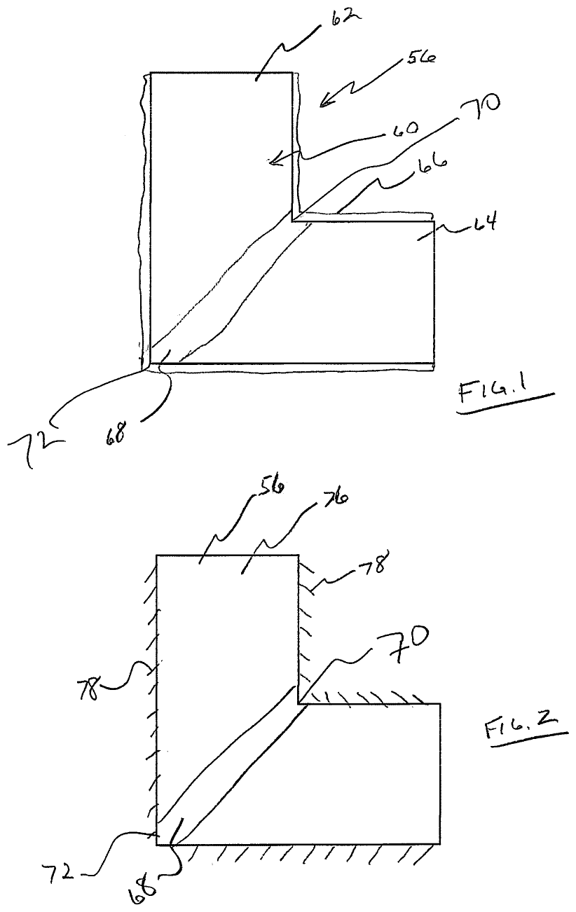

Referring to FIG. 1, corner key 56, according to an example embodiment, generally includes metal body 60, having first arm 62 and second arm 64. Metal body 60 may be hollow, partially hollow or solid and is formed of a metal that is subject to inductive heating. Metal body 60 is at least partially covered by polymer coating 66. Optionally, metal body 60 may further include angle sealant 68. According to an example embodiment, angle sealant 68 is a butyl rubber type sealant. In the depicted embodiment, first arm 62 and second arm 64 are oriented approximately 90° to one another. This should not be considered limiting as first arm 62 and second arm 64 can be oriented at other angles in the case of hexagonal or octagonal frames 50, for example. According to another example embodiment, first arm 62 and second arm 64 can be oriented from approximately 60° to 150° to one another.

Polymer coating 66 can cover portions of metal body 60 that come into contact with an interior of extruded frame members 54. Angle sealant 68 generally extends diagonally from internal corner 70 to external corner 72.

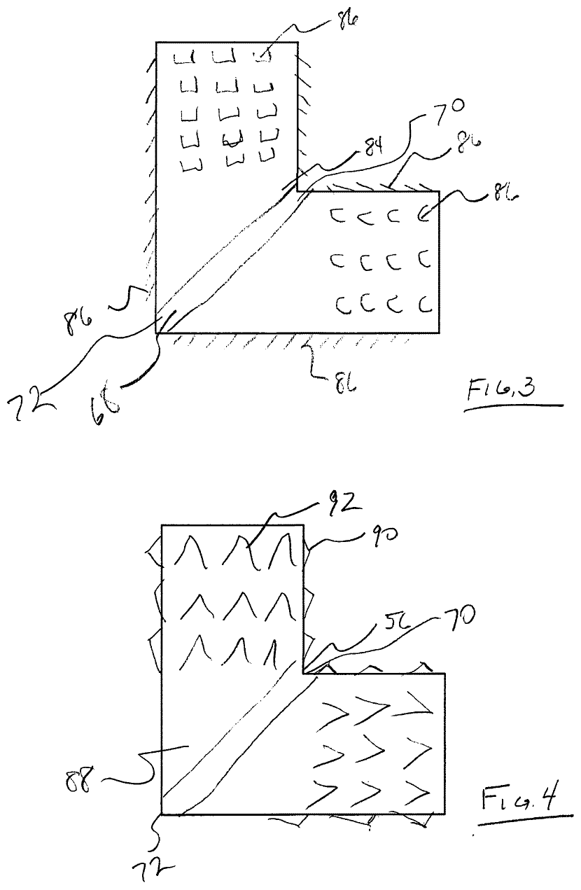

Referring to FIG. 2 according to another example embodiment corner key 56 generally includes polymer body 76 presenting metal barbs 78. According to the example embodiment, polymer body 76 includes first arm 82 second arm 82 and angle sealant 84. Metal barbs 78 are angled substantially in the same direction and are biased outwardly away from polymer body 76. Metal barbs 78 are partially embedded in polymer body 76, for example. The angled orientation of metal barbs 78 facilitates insertion of corner key 56 into frame members 54 and resists removal of corner key 76 from frame members 54. Polymer body 76 is solid or may be at least partially hollow. Metal barbs 78 are formed from a metal subject to inductive heating.

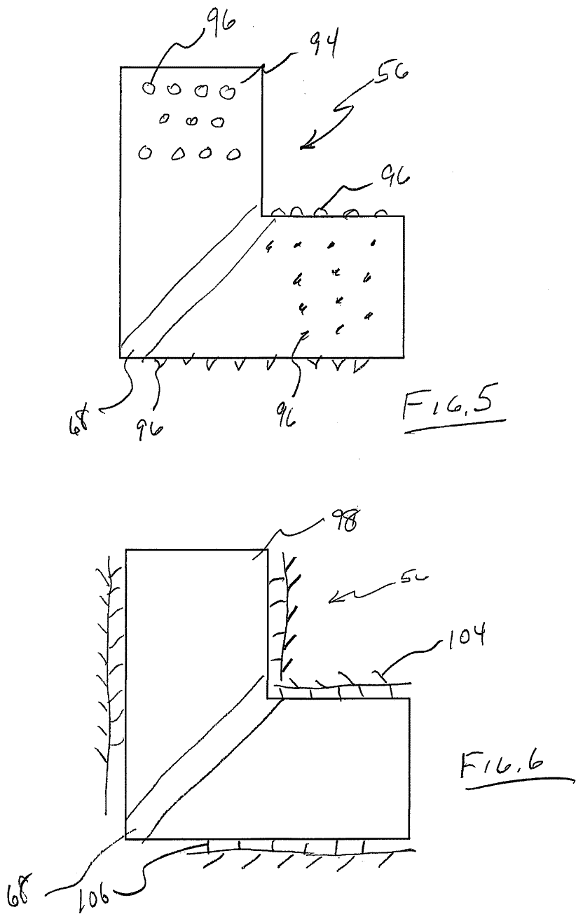

Referring now to FIG. 3, according to another example embodiment, corner key 56 includes polymer body 84 presenting surface tabs 86. Surface tabs 86 may be rounded or angular as depicted. Surface tabs 86 are, for example, oriented to facilitate insertion of corner key 56 into frame member 54 and to resist removal of corner key 56 from frame member 54. Surface tabs 86 may, for example, be embedded in polymer body 84. Surface tabs 86 are formed from a material that is subject to induction heating.

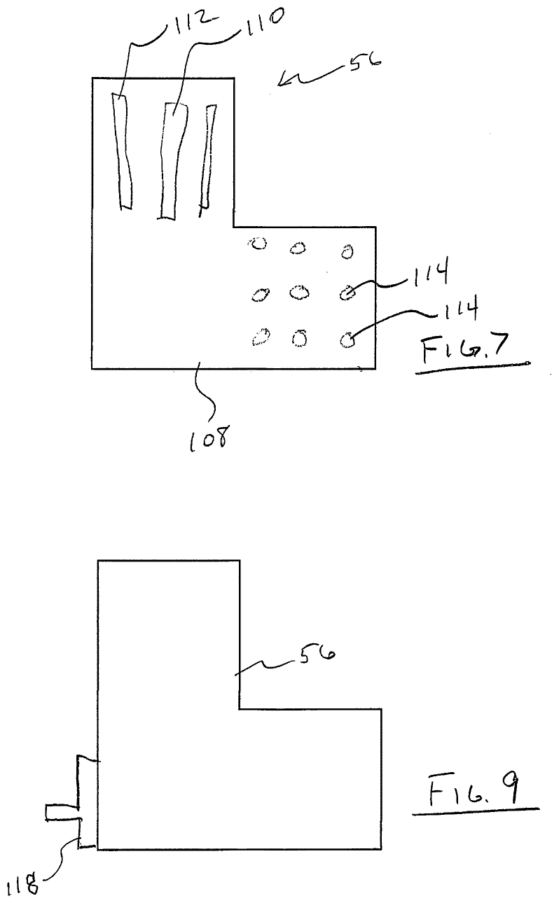

Referring now to FIG. 4, according to another example embodiment, corner key 56 includes polymer body 88 the surface of which incorporates metallic screen 90. Metallic screen 90 may be formed of expanded metal 92 for example. Expanded metal 92 may be for example oriented to facilitate insertion into and resist removal of corner key 56 from frame member 54.

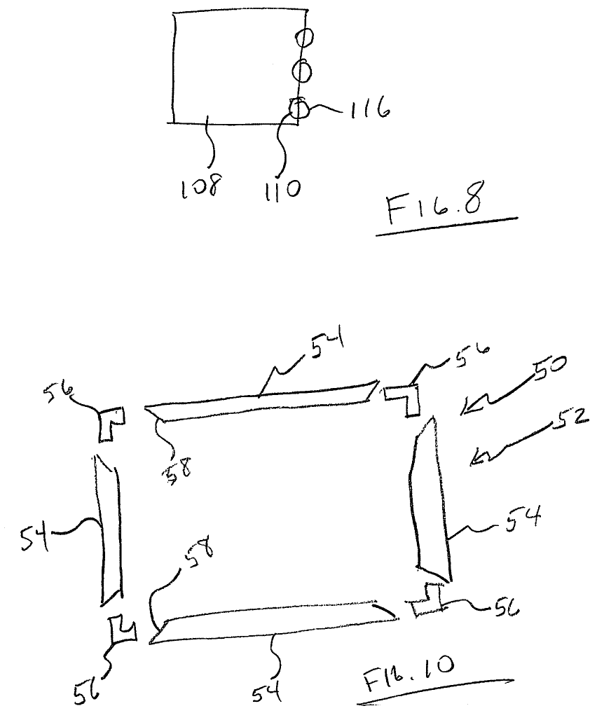

Referring now to FIG. 5, according to a further example embodiment, corner key 56 includes polymer body 94 with metal particles 96 distributed over a surface thereof. Metal particles 96 may include shavings, beads, spheroids, filings, and other shapes or forms. Metal particles 96 may be, for example, embedded in the surface of polymer body 94 so that they extend at least partially above the surface of polymer body 94.

Referring to FIG. 6 a further example embodiment of cornea key 56 is depicted. Here corner key 56 includes polymer body 98 and thin metal structure 100. Thin metal structure 100 may be secured to polymer body 98 or maybe a separate structure from polymer body 98 that is insertable with polymer body 98 into frame members 54. According to one example embodiment metal structure 100 may include externally extending tabs 104. According to another example embodiment metal structure 100 may include both externally extending tabs 104 and internally extending tabs 106. Externally extending tabs 104 and internally extending tabs 106 may extend in opposing directions from one another on opposite sides of metal structure 100.

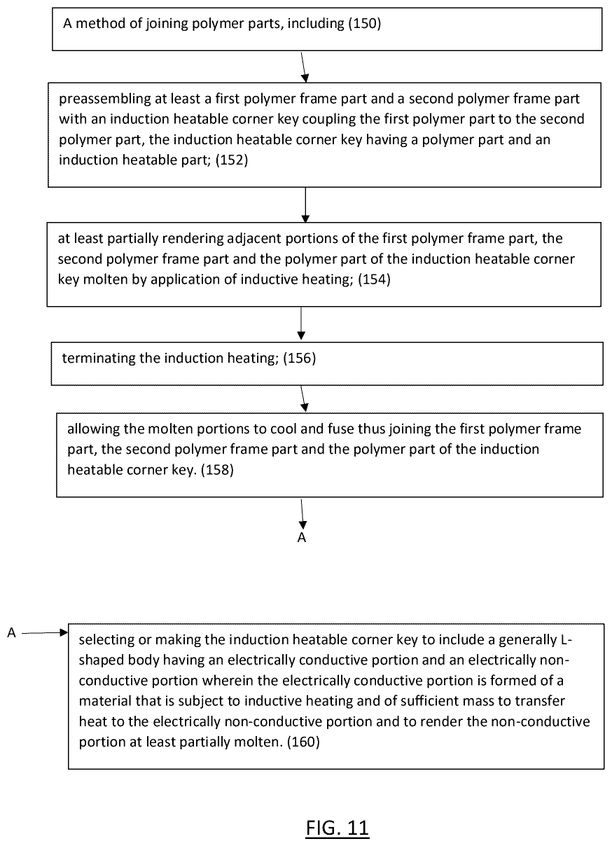

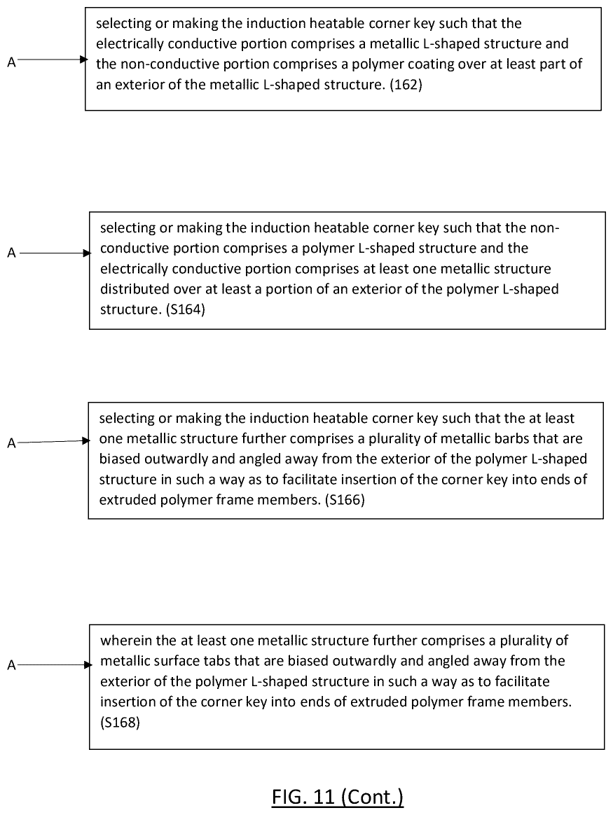

Referring now to FIGS. 7 and 8, according to another example embodiment corner key 56 includes polymer body 108 having a plurality of indentations 110 at a surface of polymer body 108. Indentations 110 can be in the form of grooves 112 or dimples 114 for example. Indentations 110 are filled with an induction heatable and meltable material 116. For example, indentations 110 can be filled with an iron polymer mixture, for example including iron filings and a vinyl or other polymer material. Alternately, indentations 110 can be filled with an electrically conducting polymer that heats and subsequently melts when subject to induction heating via electromagnetic field.

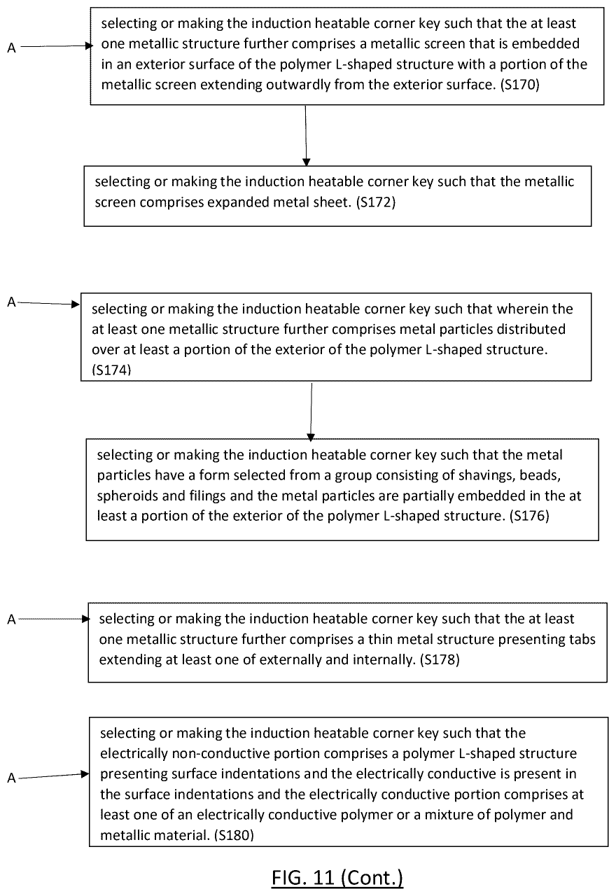

Referring now to FIG. 9, according to another example embodiment, corner key 56 further includes window hardware 118. Window hardware may include, for example, tilt latches, tilt hinges or locking hardware.

According to another example embodiment, and with reference to FIG. 11, the invention includes a method of joining polymer parts, S150 including preassembling at least a first polymer frame part 54 and a second polymer frame part 54 with an induction heatable corner key coupling the first polymer part 54 to the second polymer part 54, the induction heatable corner key 56 having a polymer part and an induction heatable part S152; at least partially rendering adjacent portions of the first polymer frame part 54, the second polymer frame part 54 and the polymer part of the induction heatable corner key 56 molten by application of inductive heating; S154 terminating the induction heating; S156 and allowing the molten portions to cool and fuse thus joining the first polymer frame part 54, the second polymer frame part 54 and the polymer part of the induction heatable corner key 56 S158.

According to another example embodiment the invention further includes selecting or making the induction heatable corner key 56 to include a generally L-shaped body having an electrically conductive portion and an electrically non-conductive portion wherein the electrically conductive portion is formed of a material that is subject to inductive heating and of sufficient mass to transfer heat to the electrically non-conductive portion and to render the non-conductive portion at least partially molten S160.

According to another example embodiment the invention further includes selecting or making the induction heatable corner key 56 such that the electrically conductive portion comprises a metallic L-shaped structure and the non-conductive portion comprises a polymer coating over at least part of an exterior of the metallic L-shaped structure S162.

According to another example embodiment the invention further includes selecting or making the induction heatable corner key 56 such that the non-conductive portion comprises a polymer L-shaped structure and the electrically conductive portion comprises at least one metallic structure distributed over at least a portion of an exterior of the polymer L-shaped structure S164.

According to another example embodiment the invention further includes selecting or making the induction heatable corner key 56 such that the at least one metallic structure further comprises a plurality of metallic barbs 78 that are biased outwardly and angled away from the exterior of the polymer L-shaped structure in such a way as to facilitate insertion of the corner key into ends of extruded polymer frame members 54 S166.

According to another example embodiment the invention the at least one metallic structure further comprises a plurality of metallic surface tabs 86 that are biased outwardly and angled away from the exterior of the polymer L-shaped structure in such a way as to facilitate insertion of the corner key into ends of extruded polymer frame members 54 S168.

According to another example embodiment the invention further includes selecting or making the induction heatable corner key 56 such that the at least one metallic structure further comprises a metallic screen 90 that is partially embedded in an exterior surface of the polymer L-shaped structure with a portion of the metallic screen 90 extending outwardly from the exterior surface S170.

According to another example embodiment the invention further includes selecting or making the induction heatable corner key such that the metallic screen 90 comprises expanded metal 92 sheet S172.

According to another example embodiment the invention further includes selecting or making the induction heatable corner key 56 such that wherein the at least one metallic structure further comprises metal particles 96 distributed over at least a portion of the exterior of the polymer L-shaped structure S174.

According to another example embodiment the invention further includes selecting or making the induction heatable corner key 56 such that the metal particles 96 have a form selected from a group consisting of shavings, beads, spheroids and filings and the metal particles 96 are partially embedded in the at least a portion of the exterior of the polymer L-shaped structure S176.

According to another example embodiment the invention further includes selecting or making the induction heatable corner key 56 such that the at least one metallic structure further comprises a thin metal structure 100 presenting tabs 102 extending at least one of externally and internally S178.

According to another example embodiment the invention further includes selecting or making the induction heatable corner key 56 such that the electrically non-conductive portion comprises a polymer L-shaped structure presenting surface indentations 110 and the electrically conductive portion is present in the surface indentations and the electrically conductive portion comprises at least one of an electrically conductive polymer 116 or a mixture of polymer and metallic material 116 S180.

According to another example embodiment the invention further includes selecting or making the induction heatable corner key 56 such that it further includes window hardware 118 coupled thereto S182.

In operation, frame 50 of fenestration structure 52 is assembled by inserting corner keys 56 into ends 58 of frame members 54. Once assembled ends 58 of frame members 54 with corner keys 56 inserted therein are subject to inductive heating. Inductive heating raises the temperature of metal body 60 or other metal parts such as metal barbs 78, surface tabs 86, metallic screen 90, metal particles 96, thin metal structure 100, or induction heatable and meltable material 116.

Heat is transferred from these structures to surrounding polymer material, raising the polymer material to its melting point and causing it to at least become partially molten. The molten polymer material flows around metal body 60 or other metal parts. When inductive heating is ended the molten polymer material cools and returns to a solid state. This causes corner keys 56 to fuse with frame members 54.

At the same time, angle sealant 68 is raised to its melting point and becomes at least partially fluid. Angle sealant 68 thus creates an airtight and watertight seal where it ends 58 of frame members 54 meet. Ends 58 of frame members 54 typically meet at a mitered corner.

Thus, application of the invention creates a frame 54 a fenestration structure 52 having strong well that square corners where frame members 54 meet and are joined with corner keys 56. Simultaneously angle sealant 68 seals a mitered corner where two ends 58 of frame members 54 meet.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112 (f) are not to be invoked unless the specific terms “means for” or “step for” are recited in a claim.

1. An induction heatable corner key, comprising:
a generally L-shaped body having an electrically conductive portion and an electrically non-conductive portion wherein the electrically conductive portion is formed of a material that is subject to inductive heating and of sufficient mass to transfer heat to the electrically non-conductive portion and to render the non-conductive portion at least partially molten.

2. The induction heatable corner key as claimed in claim 1, wherein the electrically conductive portion comprises a metallic L-shaped structure and the non-conductive portion comprises a polymer coating over at least part of an exterior of the metallic L-shaped structure.

3. The induction heatable corner key as claimed in claim 1, wherein the non-conductive portion comprises a polymer L-shaped structure and the electrically conductive portion comprises at least one metallic structure distributed over at least a portion of an exterior of the polymer L-shaped structure.

4. The induction heatable corner key as claimed in claim 3, wherein the at least one metallic structure further comprises a plurality of metallic barbs that are biased outwardly and angled away from the exterior of the polymer L-shaped structure in such a way as to facilitate insertion of the corner key into ends of extruded polymer frame members.

5. The induction heatable corner key as claimed in claim 3, wherein the at least one metallic structure further comprises a plurality of metallic surface tabs that are biased outwardly and angled away from the exterior of the polymer L-shaped structure in such a way as to facilitate insertion of the corner key into ends of extruded polymer frame members.

6. The induction heatable corner key as claimed in claim 3, wherein the at least one metallic structure further comprises a metallic screen that is partially embedded in an exterior surface of the polymer L-shaped structure with a portion of the metallic screen extending outwardly from the exterior surface.

7. The induction heatable corner key as claimed in claim 6, wherein the metallic screen comprises expanded metal sheet.

8. The induction heatable corner key as claimed in claim 3, wherein the at least one metallic structure further comprises metal particles distributed over at least a portion of the exterior of the polymer L-shaped structure.

9. The induction heatable corner key as claimed in claim 8, wherein the metal particles have a form selected from a group consisting of shavings, beads, spheroids and filings and the metal particles are partially embedded in the at least a portion of the exterior of the polymer L-shaped structure.

10. The induction heatable corner key as claimed in claim 3, wherein the at least one metallic structure further comprises a thin metal structure presenting tabs extending at least one of externally and internally.

11. The induction heatable corner key as claimed in claim 1, wherein the electrically non-conductive portion comprises a polymer L-shaped structure presenting surface indentations and the electrically conductive is present in the surface indentations and the electrically conductive portion comprises at least one of an electrically conductive polymer or a mixture of polymer and metallic material.

12. The induction heatable corner key as claimed in claim 1, further comprising window hardware coupled thereto.

13. The induction heatable corner key as claimed in claim 1, further comprising a sealant or a butyl sealant on a surface thereof whereby mitered corners of two frame members, the joinder of which is facilitated by use of the induction heated corner key are sealed.

14. A method of joining polymer parts, comprising:
preassembling at least a first polymer frame part and a second polymer frame part with an induction heatable corner key coupling the first polymer part to the second polymer part;
at least partially rendering adjacent portions of the first polymer frame part, the second polymer frame part and the polymer part of the induction heatable corner key molten by application of inductive heating;
terminating the induction heating; and
allowing the molten portions to cool and fuse thus joining the first polymer frame part, the second polymer frame part and the polymer part of the induction heatable corner key.

15. The method as claimed in claim 14, further comprising: selecting or making the induction heatable corner key to include a generally L-shaped body having an electrically conductive portion and an electrically non-conductive portion wherein the electrically conductive portion is formed of a material that is subject to inductive heating and of sufficient mass to transfer heat to the electrically non-conductive portion and to render the non-conductive portion at least partially molten.

16. The method as claimed in claim 15, further comprising: selecting or making the induction heatable corner key such that the electrically conductive portion comprises a metallic L-shaped structure and the non-conductive portion comprises a polymer coating over at least part of an exterior of the metallic L-shaped structure.

17. The method as claimed in claim 15, further comprising: selecting or making the induction heatable corner key such that the non-conductive portion comprises a polymer L-shaped structure and the electrically conductive portion comprises at least one metallic structure distributed over at least a portion of an exterior of the polymer L-shaped structure.

18. The method as claimed in claim 15, further comprising: selecting or making the induction heatable corner key such that the at least one metallic structure further comprises a plurality of metallic barbs that are biased outwardly and angled away from the exterior of the polymer L-shaped structure in such a way as to facilitate insertion of the corner key into ends of extruded polymer frame members.

19. The method as claimed in claim 15, further comprising: selecting or making the induction heatable corner key such that the at least one metallic structure further comprises a metallic screen that is partially embedded in an exterior surface of the polymer L-shaped structure with a portion of the metallic screen extending outwardly from the exterior surface.

20. The method as claimed in claim 15, further comprising: selecting or making the induction heatable corner key such that the at least one metallic structure further comprises metal particles distributed over at least a portion of the exterior of the polymer L-shaped structure.

21. The method as claimed in claim 15, further comprising: selecting or making the induction heatable corner key such that the electrically non-conductive portion comprises a polymer L-shaped structure presenting surface indentations and the electrically conductive is present in the surface indentations and the electrically conductive portion comprises at least one of an electrically conductive polymer or a mixture of polymer and metallic material.

22. A method of joining polymer parts, comprising:
preassembling at least a first polymer frame part and a second polymer frame part with an induction heatable corner key coupling the first polymer part to the second polymer part;
subjecting at least a portion of the induction heatable corner key and at least a portion of each of the first polymer part and the second polymer part to induction heating sufficient to render at least a portion of the induction heatable corner key that is formed of polymer material and at least a portion of each of the first polymer part and the second polymer molten;
terminating the induction heating; and
allowing the molten portions to cool, fuse and harden.
